(19) United States
(12) Patent Application Publication
(10) Pub. No.: US 2009/0154978 A1
(43) Pub. Date: Jun. 18, 2009

(54) MEDIA FOR USE WITH ACTIVATION PRINTER AND ACTIVATION PRINTER THEREFOR

(75) Inventor: Clive Lawrence Ayling, Cambridgeshire (GB)

Correspondence Address: JOHN P. DE LUCA, 17420 RYEFIELD CT., DICKERSON, MD, 20842, US

(73) Assignee: THE TECHNOLOGY PHARTNERSHIP PLC., HERTFORDSHIRE (GB)

(21) Appl. No.: 12/301,466

(22) PCT Filed: May 18, 2007
(86) PCT No.: PCT/GB07/01867

§ 371 Date: Nov. 19, 2008

(30) Foreign Application Priority Data
May 19, 2006 (GB) 0610094.5

(51) Int. Cl. B41J 2/315; G03C 1/00

(52) U.S. Cl. 400/120.02; 430/495.1

(57) ABSTRACT

Media for use with an activation printer, the media comprising at least one surface having an array of pixels deposited thereon, each pixel containing at least one activatable colourant, wherein different pixels have different colourants and the pixels are arranged in a predetermined pattern, such that, in use, a multicolour image can be produced when the paper is passed through an activation printer. An activation printer for use with the above media comprising means for detecting the pattern of pixels in the array on the media so that the printer is able to determine which pixels on the paper to activate in order to produce the desired multicolour image.

The invention relates to colour printing and, in particular, to colour printing using thermal, light (UV, IR or other suitable wavelength), pressure or other forms of activation. Indeed any printing where individual pixels of colourant (a proto-dye) are activated by a suitable printhead is encompassed. The activation occurs by the transfer of energy from a printhead to the pixels. This will be referred to as activation printing.

Whilst much of the discussion surrounds thermal printing, if a colourant can be activated by another means, the present invention can be utilised to produce a colour image. References to higher or lower temperatures in connection with thermal printing are analogous to higher or lower pressures, or higher or lower light intensities, depending on the type of activation printing being considered.

In one example of a known type of activation printing, thermal media is used in many point-of-sale applications. The media is usually a paper, loaded with a thermally-activated colourant. In the known media, one surface of the media is provided with a continuous layer of the thermally activatable colourant. This can be done by any simple spreading action using a doctor blade. Alternatively, and of use when the proto-dye is only required in selected areas, the deposition of the proto-dye can be done by any standard printing method such as offset lithography or screen printing. This selective printing helps to minimise the costs of applying proto-dye over the whole surface if it is not needed. In use, when heat is applied to selected portions of the side of the media having the colourant, the colour displayed on the media changes. Typically, this is used in the generation of till receipts, when the media is, generally white and monochrome black text is produced on the paper.

In addition to a single layer of colourant, a second layer of colourant may be applied over the first. One of the layers, usually the second upper layer, is activatable at a higher temperature than the other layer. This higher activation temperature colourant is typically darker than the lower activation temperature colourant, as when activated at the lower temperature, a lighter colour is produced and then, if the media is heated to the higher temperature, both colourants are activated and so the second colour is usually darker in order to override the lighter colour. However, it is possible for the higher activation temperature component to be a bleach which will lighten the first colourant.

In order to activate the desired colour in the specified areas, the printer requires special software to define whether a pixel should be the first colour or the second colour. The second colour achieved is actually a mixture of the first lighter and second darker colourants, as both colourants are activated when the higher of the two temperatures is used. Thus, the colour of the dye used at the higher temperature is usually black, to hide the colour that is released at the lower temperature in the same pixel.

Graphics are sometimes used on thermal media, but these are often printed on the reverse of the media and not created by the use of a thermally activatable colourant. However, if a thermally activatable colourant is used to produce the graphics, the colours are very limited and the images are of poor quality due to the limited choice of colours.

Thus, it is clear that a media, having similar constituents and hence material cost, to known colour thermal paper or media suitable for other colour activation printing, but which enabled full process colour printing, would be of great commercial interest.

US 2005/0243689 describes a system and method for synchronisation of a pixilated labelling media and a digital medium. This is achieved by placing synchronisation pixels amongst the colour pixels which are to be used to form the colour image. The synchronisation pixels do not provide any colour to the overall image and therefore the clarity and quality of the final colour image is adversely affected. In addition, as the system is intended for use on digital media which are spinning when being read, the media is first scanned to identify the location of the synchronisation pixels and is then subsequently imaged to activate the colour pixels thereby requiring at least two different and distinct passes over the surface of the media.

U.S. Pat. No. 6,106,173 teaches the provision of colour media in which the colour forming means are inside the media (which is formed from a base layer, a layer of micro-capsules and a film covering layer) and by patterning the media by the action of an activating print head. The micro-capsules are activated by a combination of pressure and temperature, but these micro capsules are supplied in a uniformly distributed layer of three different micro-capsules, each representing different colours. There is no predetermined pattern to the micro-capsules and therefore no recognition of the location of specifically coloured pixels is required, but rather the image which is to be produced is determined solely by the signals sent to the print heads.

According to the present invention, there is provided a media for use with an activation printer, the media comprising:
at least one surface having an array of pixels deposited thereon, each pixel containing at least one activatable colourant, wherein different pixels have different colourants and the pixels are arranged in a predetermined pattern, such that, in use, a multicolour image can be produced when the paper is passed through aan activation printer.

The present invention also provides an activation printer for use with the media having an array of pixels of different heat activatable colourants as described above, the printer comprising:
a means for activating selected parts of the media as it passes through the printer;
means for driving the activating means to deliver the activating energy to the selected parts of the media in order to produce the desired image; and
means for detecting the pattern of pixels in the array on the media so that the printer is able to determine which pixels on the paper to activate in order to produce the desired multicolour image.

Thus, by the provision of an array of differently coloured pixels, the present invention enables a process colour to be produced in which the colour of a “super pixel” is determined by activating the appropriate number of coloured “small pixels” within it. Typically a “super pixel” is made up of 3 to 9 smaller pixels. From a distance, the human eye averages the colours received and assumes that the large pixel was in fact only one colour, usually a colour that is not actually evenly present as a base colour. In this way, images having many different colours and shades of colours can be produced, thereby resulting in an enhanced image or images on the media.

The activation printer may include a thermal printhead, a light emitting printhead or a pressure emitting printhead.

Although mentioned above in connection with the use of till receipts, an improved colour printer could be used in many different applications, such as unmanned kiosk colour printers for, for example, colour map printers or internet page colour printers. Alternatively, it could be used as a portable colour printer, such as colour coded ticket machines or labellers, low cost colour “Polaroid® style” instant cameras, “Polaroid® style” instant colour photograph printer with a link to a mobile phone or other image capture/storage device or a colour toy camera printer. It could also be utilised in anti-counterfeit applications, such that the media is only printable when a code number to identify the pseudorandom pattern used is known. Alternatively, it could be used in document tracing applications, as all printed documents could be traced via their pseudorandom pattern to their source.

The media can be of any type that can receive suitable activatable colourants and is typically a paper product. The thermal colourants are typically encapsulated luco-dyes such as are currently used in dual-colour thermal media.

The colourants are patterned on the media such that each individual pixel has one or more known colour states when activated.

The pattern of pixels could be created by any printing process that does not damage the thermally activatable colourants.

The pattern could be a repeat pattern, if a non-digital printing/production process is used and this would simplify how the printer knows which pattern of pixels is used, as only a small amount of data would be needed to define the repeat pattern. The repeat pattern could be very short e.g. 3 pixels long or it could be very long e.g. 8000 pixels long at 200 pixels per inch, but still short enough to fit in one revolution of a rotary conventional printing process such as an offset press. In the case of a long repeat pattern the printer may either hold the pattern in a look-up table in memory, or for appropriate patterns, an algorithm could be used. Alternatively, the pattern could be a predictable non-repeat pattern, if a digital printing/production process is used. The formula for the pattern could be stored in the printer and the parameters used to define the pattern then passed to the printer prior to using the particular media.

The media may contain “encoder” markings for use in synchronising the firing pattern of the printhead to the pattern of colourants. A printed encoder pattern may be provided on the surface of the media on a non-imaged area of the media. Alternatively, a non-visible encoder pattern is provided within the array of pixels on the surface of the media such that the density of the pixels used to create the visible image is not reduced. A non-visible encoder pattern may be formed from a fluorescent dye included in one or more of the activatable colour coatings used in the pixels.

The markings could be printed on the rear of the media so as not to be visible when viewing the main image or could be printed on either surface of the media in an ink that is not visible to the human eye, usually UV, fluorescing or IR blocking inks. One of the encapsulated colourants which while inactivated is invisible to the human eye may be visible to sensors operating on non-visible wavelengths such as UV or IR.

Thus, the “encoder” markings do not affect the quality of the colour image which is produced as the markings are either invisible to the human eye or located away from the image itself.

The printer needs to know two separate things: firstly, the type of media being used e.g. is it RGBRGB or is it CMYCMY or is it RGBBGR etc. This may be hard coded in to the printer, such that the printer can only be used with a specific type of media or alternatively the information could be selected by the user or automatically communicated to the printer by a feature or RFID tag on the media or by a feature or RFID tag on its media cassette or media packaging, or it could be deduced by the printer by the positions of the encoder marks on the media. For example, e.g. if * implies a fluorescing colour then perhaps there might be two media types manufactured: R*GBR*GBR*GB and C*MYCMYC*MYCMY and in this example the printer would tell by the increased distance between the fluorescence markers that the first media was RGB and the second was CMY. The second thing the printer needs to know is how to keep in sync with the pattern. A regular encoder signal is the most usual way of doing this e.g. by making all R colourant fluoresce etc. Alternatively and/or additionally, the formula for the pattern could be seeded with a number to create the pattern that predicts what order the colours are in or when they start relative to the encoder pattern. The seed number could be information passed to the printer by the RFID tag or similar.

Alternative methods include recognising the pattern over a particular length of media passed through the printer, via RFID means or by any other suitable method.

The printer also contains a means for synchronizing the firing pattern of the print head to the pattern of the media and this could be by use of an IR/UV illumination device and an appropriate optical sensor.

As the synchronisation of the fixing pattern to the pixels on the media can be achieved by sensing something other than the colourant pixels themselves, it is possible for the printer to use only a single pass over the media when printing, with an activation device activating the colourants to form the image and a separate detecting means for reading the encoder markings.

As an alternative example, the pattern could be regular, for example, three colours: cyan, magenta, yellow, cyan, magenta, yellow, or pseudorandom in order to disperse unwanted visible patterns in the final image that attract the notice of the human eye. The psueodorandom pattern may be a pattern that repeats only after a very large number of pixels, e.g. greater than 1000. Alternatively, the pattern may be predictable is that, whilst it does not repeat, it is based on a predictable sequence, e.g. the digits in pi.

It is also clear that certain patterns of proto-dye produce effects that are more readily noticed by the human eye than others. It is well known that vertical columns and horizontal columns are the worst. Diagonal lines are known to be better. The smaller the pixel dimensions the better and, best of all, a pseudorandom dispersion of the proto-dye colours around the media in very small pixels is desired.

The pattern could be such that each pixel contains one colourant only and each colourant may have the same or different activation temperatures. The pattern could also be arranged such that each pixel contains more than one colourant, these colourants having significantly different activation temperatures. The colourant of a higher activation temperature is preferably a darker colour than a lower activation temperature colourant, so that it dominates when activated. The darker colour is preferably black,

Alternatively, upon activation, the colourant with the higher activation level may alter the hue or the saturation of the colour of the pixel previously produced by the colourant with the lower activation level acting alone.

The media may, through some other method other than having an encapsulated colourant dispersed therein, change to black when heated to a higher temperature than that used to activate the colourant present. Such a process could be, for example, an oxidation method.

As a further alternative on the two colourants in each pixel, each pixel may contain two different shades of the same colour, for example, light magenta and magenta, light yellow and yellow, such that this two-tone capability is helpful when printing areas of light colouration. For example, it is known that a white area with two randomly positioned pink dots is a less glaring print feature than the same area with a single red dot in it even if both areas contain the same total amount of colour.

Alternatively, the second dye could be used to move the hue of the pixel around the gamut. Thus the first colour could be cyan, the second colour yellow and the result is green. This will improve the overall gamut of the system.

By increasing the number of colours used, it is possible to increase the quality of the colour gamut available. Thus, the use of six primary colours: cyan, magenta and yellow (which together cover the gamut reasonably) together with red, blue and green (which also cover the gamut but with different saturation limits in different hues) would produce an overall better coverage of the gamut. The production cost will not be significantly different as, although a larger press is required, e.g. a six colour press not a three colour press, the same total amount of proto-dye is used.

The best colour gamut from subtractive colour dyes can be achieved by having one of C, M or Y colour dye activated in each pixel at the lowest activation temperature, a different one of C,M or Y colour dye activated at a higher activation temperature and the last colour or black activated at a third activation temperature.

For a pseudorandom pattern to work, the printer also needs to know the pseudorandom pattern. An additional encoder signal is needed in order to keep the printer in sync with the repeated start positions of the pattern. The pseudo random pattern need not be larger than 1 cm before repeating in most typical applications. Typically, the manufacturing process of the media will include a rotary repeat process, so the maximum pseudo-random length will be limited in practice by the circumference of the rotary printing process used.

Where media samples of more than one pseudo-random pattern are available, then it will be necessary to inform the printer which pattern is used when loading the new media samples through methods such as RFID or mechanical encoding of the media, or by having markings on the spool or case work on which the media is loaded or placing a code on its packaging. This gives security protection to the supply of media making the process more attractive to a manufacturer or to an owner who wishes their printed material to be difficult to counterfeit or who wishes it to be traceable.

The pattern preferably has a ratio of colours available that enable good process colour formation, thereby creating a distribution of primary colour pixels within a larger pixel, that approximate to a desired “process” colour. There might be a variety of patterns used on the media, with the identification of each pattern coded into the media or its packaging, so that the printer can identify which pattern is present on the media at any particular time.

If the pixels are not full-width stripes running across the media, then it is necessary to be extremely careful, to align the media correctly to the printhead, whether it be a thermal, light or pressure printhead. If the media is out of line by anything more than 10 to 20% of the pixels width, then each heater element on the thermal head may activate both the desired pixel, and, unintentionally, its neighbour. Typically, thermal printers hold the media to an accuracy of only a few tenths of a millimetre, thus the pixel may need to be one millimetre in width. Width here refers to the dimension perpendicular to the direction of travel of the media passed the thermal printhead.

Pixel height, the dimension in the direction of travel of the media under the thermal printhead, can be smaller than the pixel width. When a thermal printhead is used, then the height will be limited practically by the skew errors in the mechanism. Typically, the skew found in thermal printers is less than 20 microns across the media, thus the image resolution may be 125 dpi or better in the direction of travel.

Thus, a thermal printer will work with a media having proto-dye pixels at a resolution better than 50×125 dpi. The thermal printhead must have a heater element that is small enough to address the prototype pixels individually.

If the proto-dye pixels are actually columns running the full width of the media (i.e. stripes), then a thermal printhead will address, when synchronised in the direction of travel of the media with the encoder, only one colour of proto-dye at any one moment and thus the alignment of the media to the thermal printhead in the direction perpendicular to travel is not relevant. The image resolution may therefore be 200 dpi or greater in the direction perpendicular to the media travel in this case.

If the printhead contains a scanning printhead, such as a small thermal printhead or a laser or LED, then synchronization is possible in both directions, i.e. the direction of media travel and the direction of printhead scanning. Thus, the resolution of the media is limited only by the thermal behaviour of the media. Since the thermal printer in monochrome exists at very high resolutions, it is expected that thermal printing in colour can be possible at up to and above 600 dpi using a scanning printhead.

The printer may further comprise means for synchronising the activating means to the real-time passing of the pixels past the activation means so that the printer is able to selectively activate pixels on the medium in order to produce the desired multicolour image with a single pass of the media through the printer.

The printer may also further comprise means for controlling the duration or intensity of any activation of a pixel to thereby control the amount of colourant activated in that pixel. This allows the printer to generate different shades of a particular colour without needing to have different colourants present in the same pixel.

One example of the present invention will now be described with reference to the accompanying drawings, in which:

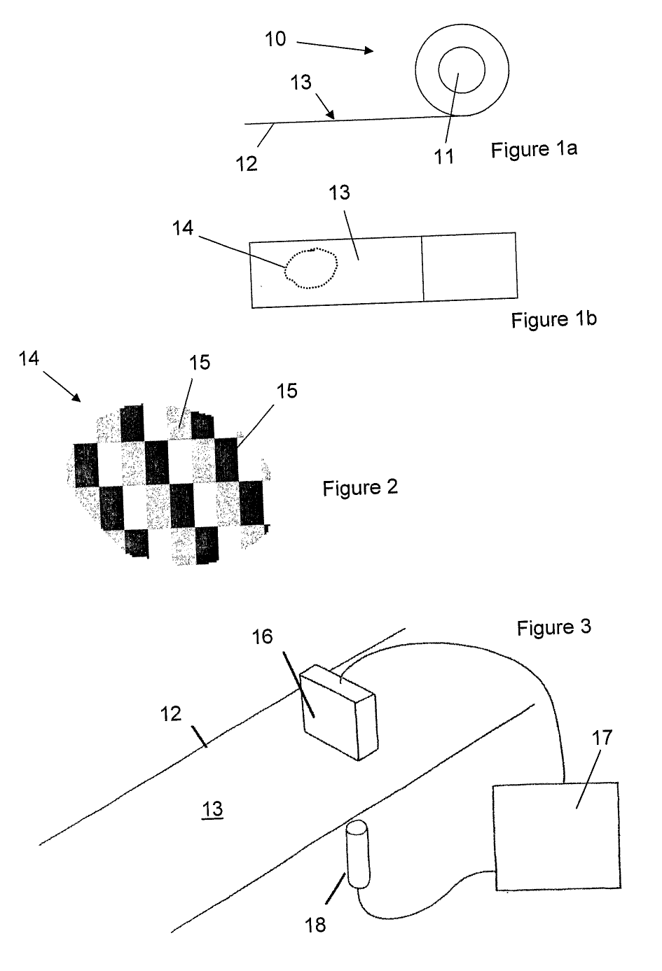

FIGS. 1A and 1B show side and plan views of media which can be used in the present invention;

FIG. 2 shows an array of pixels used on the media of FIGS. 1A and 1B;

FIG. 3 which shows a schematic representation of parts of a printer according to the present invention; and

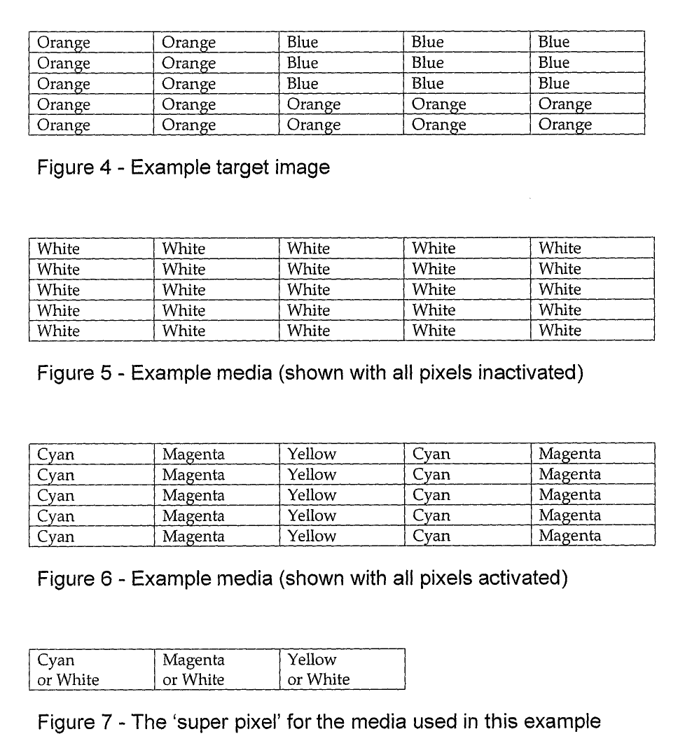

FIGS. 4 to 14 illustrate how a normal image is converted into an array of activation instructions for printing the image on a particular media.

FIG. 1 shows a typical roll of media 10 which could be used in the present invention. The roll 10 has a central core 11, around which the media 12 is wound such that it can easily be dispensed therefrom. In this example, the media is thermal paper, but it could be any suitable type of media.

At least one surface 13, in this case the upper surface in the Figures, of the media 12 is provided with an array 14 of pixels 15. Each pixel contains at least one of a number of different colourants, but in the preferred embodiment, at least two colourants are applied in distinct layers. The colourants are typically transparent before activation and different colourants are activated at differing temperatures. The lower layer, i.e. the layer next to the surface of the media is typically a lighter colour than the upper layer, and the lower layer is activated at a lower temperature than the upper layer.

The pixels may be arranged in a regular pattern, as shown in FIG. 2, although a pattern which has no discernable straight or diagonal lines is preferred, as a user is less likely to notice such patterns. As such, a pseudo random pattern is preferred.

Individual pixels 15 can be grouped into a larger pixel, typically of 3 to 9 individual pixels, such that the overall process colour of the “larger” pixel is determined by activating the appropriate numbers of individual pixels of the available colours.

FIG. 3 shows a schematic arrangement of some elements in a thermal printer through which the thermal media 12 passes beneath a thermal printhead 16. The printhead and its operation is controlled by a print controller 17 which is connected to an encoder 18 which can be utilised to detect the pattern of the pixels on the media 12. The combination of the encoder 18 and the controller 17 direct the printhead to activate the appropriate pixels, and at the required intensity, on the surface 13 of the media in order to produce the desired colour in each individual pixel, thereby generating the colour image that is required.

More than one encoder 18 could be used to reduce the possibility of misalignment between the printhead 16 and the array of pixels 14. The printhead 16 may have a single activation device (not shown), such as a laser or other light, heat or pressure source, or may be provided with an array of such activation devices. However, the possibility of misalignment is reduced by using a single activation device in the printhead 16.

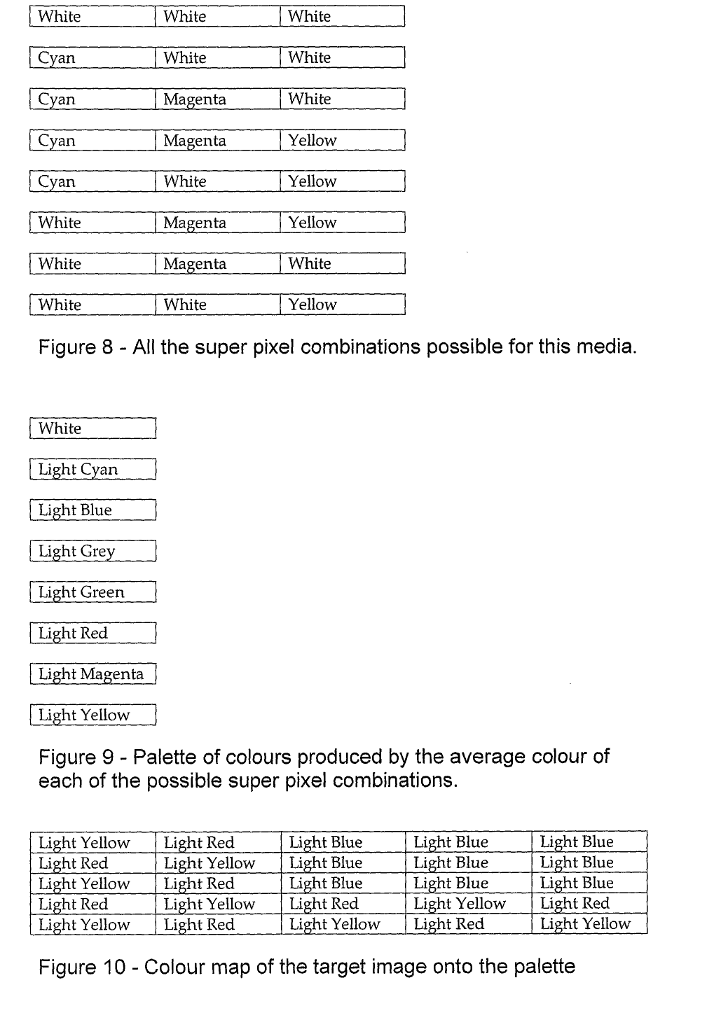

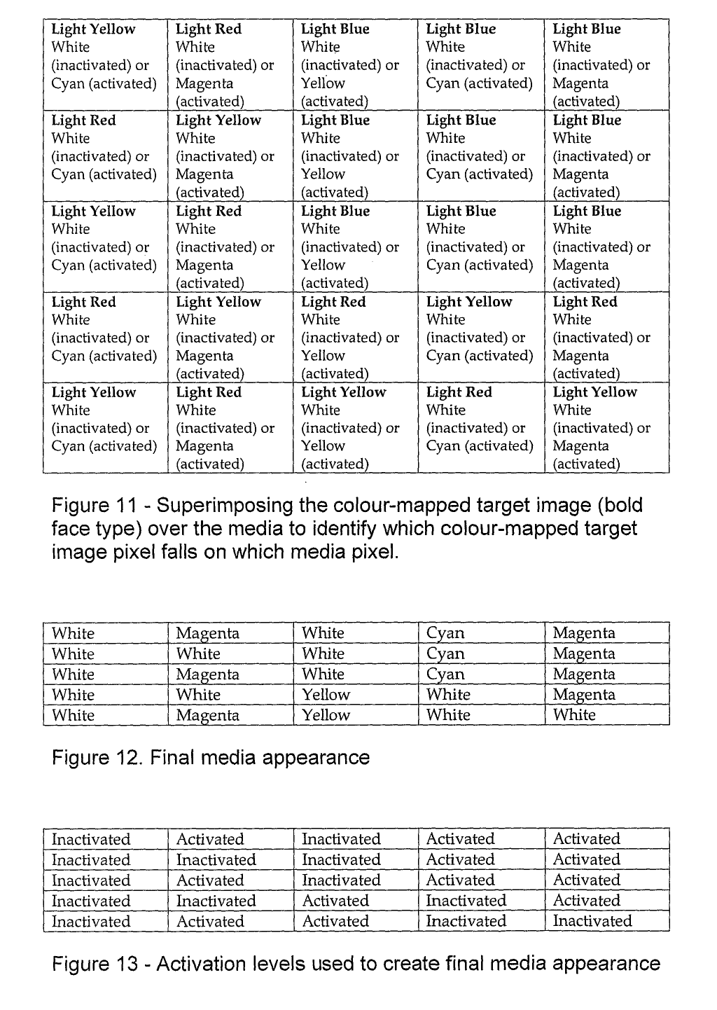

In order to convert any normal image (FIG. 4) into a suitable pattern of pixels for imaging on media according to the invention (FIGS. 5 and 6), it is necessary firstly to work out the smallest combination of pixels which contain all the unique pixels there are (a ‘super-pixel’), e.g. for a pattern of RGBRGBRGB, this is three pixels (FIG. 7). Then, it is necessary to work out the average colour of this super-pixel in each of the different states of the pixels with in it, e.g. WWW, RWW, WGW, WWB, RGW, RWB, WGB, RGB [where W=white inactivated state] (FIG. 8). This list can be reduced by removing any replicated colours (there aren't any in the RGB example, but in other patterns of pixels, there can be a lot of combinations that produce the same average colour). This gives a “palette” of colours for this particular type of media (FIG. 9). Standard error-dithered or non-dithered colour mapping algorithms can be applied to map the target image into the palette for the particular media to produce an intermediate image (FIG. 10). Finally, the intermediate image is super-imposed over media (FIG. 11). Each pixel within the super-pixel is activated according to whether the colour of the pixel in the intermediate image is formed by a super-pixel with this particular pixel activated or not, i.e. the colour in each pixel in the intermediate image is replaced by the W,R,G or B present in that column in the ‘super-pixel’ to which it corresponds. Where there were multiple super-pixels that correspond to the same palette colour, a random algorithm is used to pick between the relevant super-pixels to avoid building up artefacts in the image. This final image (FIG. 12) can now be printed on any standard printer to see a simulation of the image that would be created if the target image was printed using media according to the invention. To produce the actual image required to drive a thermal printhead that activates the media of the invention, it is necessary to have a final step of converting all white pixels to 0, all lower-temp colour pixels to 1, and all higher-temp colour pixels to 2 (FIG. 13). In the RGBRGB example, there are no higher-temperature colours so the final image would contain just 0s and 1s. This final image can then be used to drive the thermal head. If the media is correctly aligned to the firing of the printhead, then the 1s will produce the correct lower-temperature colours in the media etc.

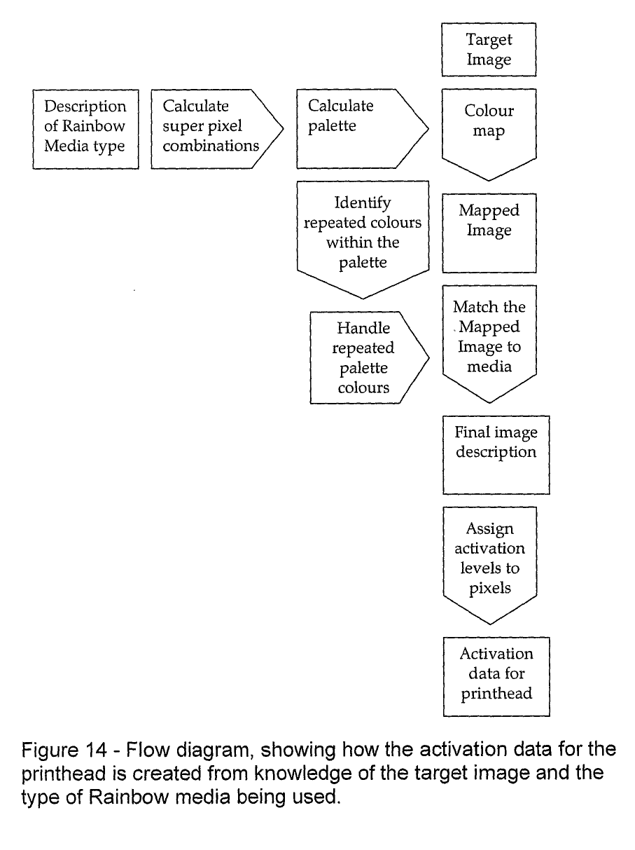

FIG. 14 is a flow diagram to further illustrate the above steps.

1. Media for use with an activation printer, the media comprising:
at least one surface having an array of pixels deposited thereon, each pixel containing at least one activatable colourant, wherein different pixels have different colourants and the pixels are arranged in a predetermined pattern, such that, in use, a multicolour image can be produced when the paper is passed through an activation printer.

2. Media according to claim 1, further comprising indication means for allowing the thermal printer to determine the pattern and/or the position in the pattern on which pattern is to occur.

3. Media according to claim 2, wherein the indication means is provided on the surface of the media.

4. Media according to claim 2, wherein a printed encoder pattern is provided on the surface of the media on a non-imaged area of the media.

5. Media according to claim 2, wherein a non-visible encoder pattern is provided within the array of pixels on the surface of the media such that the density of the pixels used to create the visible image is not reduced.

6. Media according to claim 5, wherein a non-visible encoder pattern is formed from a fluorescent dye included in one or more of the activatable colour coatings used in the pixels.

7. Media according to any one of claims 1 to 6, wherein the pattern is a repeat pattern.

8. Media according to any one of the preceding claims, wherein the pattern is predictable.

9. Media according to any one of the preceding claims, wherein each pixel contains only one activatable colourant.

10. Media according to any one of claims 1 to 8, wherein each pixel contains at least two colourants, these colourants having significantly different activation levels.

11. Media according to claim 10, wherein any colourant with a higher activation level is a darker colour than the lower activation level colourant.

12. Media according to claim 10, wherein, upon activation any colourant with a higher activation levels alters the hue or the saturation of the colour of the pixel previously produced by the colourant with a lower activation level acting alone.

13. An activation printer for use with media according to any one of the preceding claims, the printer comprising:
a means for activating selected parts of the media as it passes through the printer;
means for driving the activating means to deliver the activating energy to the selected parts of the media in order to produce the desired image; and
means for detecting the pattern of pixels in the array on the media so that the printer is able to determine which pixels on the paper to activate in order to produce the desired multicolour image.

14. An activation printer according to claim 13, wherein the means for detecting the pattern includes an encoder.

15. An activation printer according to claim 13, further comprising means for synchronising the activating means to the real-time passing of the pixels past the activation means so that the printer is able to selectively activate pixels on the medium in order to produce the desired multicolour image with a single pass of the media through the printer.

16. An activation printer according to claim 13, wherein the printhead is one of a thermal printhead, a light emitting printhead or a pressure printhead.

17. An activation printer according to any one of claims 13 to 16, further comprising means for controlling the duration or intensity of any activation of a pixel to thereby control the amount of colourant activated in that pixel.
